(19) United States
(12) Patent Application Publication
(10) Pub. No.: US 2023/0133070 A1
(43) Pub. Date: May 4, 2023

(54) EXCLUDING TRANSACTIONS FROM RELATED USERS IN TRANSACTION BASED AUTHENTICATION

(71) Applicant: Capital One Services, LLC, McLean, VA (US)

(72) Inventors: Joshua Edwards, Philadelphia, PA (US); Vyjayanthi Vadrevu, Pflugerville, TX (US); Tyler Maiman, Melville, NY (US); Samuel Rapowitz, Roswell, GA (US); Viraj Chaudhary, Katy, TX (US); David Septimus, New York, NY (US); Jenny Melendez, Falls Church, VA (US)

(21) Appl. No.: 17/513,411

(22) Filed: Oct. 28, 2021

(51) Int. Cl. G06Q 20/40; G06N 20/00

(52) U.S. Cl. CPC G06Q 20/401; G06N 20/00

(57) ABSTRACT

Methods, systems, and apparatuses are described herein for improving computer authentication processes through excluding transactions from related users in transaction-based authentication. A computing device may receive a request for access to an account from a first user. The computing device may provide account data to a machine learning model. The computing device may receive data indicating a relatedness between the users from the machine learning model. The computing device may generate a modified set of false merchant choices for the first user by excluding merchants with which one or more users related to the first user has conducted a transaction within a predetermined time period. An authentication question may be generated, and access to the account may be provided based on a response to the authentication question.

### FIELD OF USE

Aspects of the disclosure relate generally to account security. More specifically, aspects of the disclosure may provide for improvements in the method in which authentication questions are generated by computing devices by processing transaction and merchant information.

### BACKGROUND

As part of determining whether to grant a user access to content (e.g., as part of determining whether to provide a caller access to a telephone system that provides banking information), a user of the user device may be prompted with one or more authentication questions. Such questions may relate to, for example, a password of the user, a personal identification number (PIN) of the user, or the like. Those questions may additionally and/or alternatively be generated based on personal information of the user. For example, when setting up an account, a user may provide a variety of answers to predetermined questions (e.g., “Where was your father born?,” “Who was your best friend in high school?”), and those questions may be presented to the user as part of an authentication process. As another example, a commercially-available database of personal information may be queried to determine personal information for a user (e.g., their birthdate, birth location, etc.), and that information may be used to generate an authentication question (e.g., “Where were you born, and in what year?”). A potential downside of these types of authentication questions is that the correct answers may be obtainable and/or guessable for someone who has information about a particular user.

As part of authenticating a computing device, information about financial transactions conducted by a user of that computing device may be used to generate authentication questions as well. For example, a user may be asked questions about one or more transactions conducted by the user in the past (e.g., “Where did you get coffee yesterday?,” “How much did you spend on coffee yesterday?,” or the like). Such questions may prompt a user to provide a textual answer (e.g., by inputting an answer in a text field), to select one of a plurality of answers (e.g., select a single correct answer from a plurality of candidate answers), or the like. In some instances, the user may be asked about transactions that they did not conduct. For example, a computing device may generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user may be able to glean personal information about the legitimate user.

One issue with transaction-based authentication questions is that they might relate to transactions that are not particularly memorable or confusing to a user. For example, users might consume or use products purchased from a merchant by a family member or a co-inhabitant, such that the users might not remember who made the purchases from the merchant, meaning that those users might not be able to easily and/or accurately answer authentication questions based on those transactions. This may particularly be the case for a user that regularly shares expenses (e.g., household expenses, like the responsibility of buying toiletries) with another person, as certain transactions might not be particularly memorable to the user whether she made a payment for a particular product or a service. As such, an authorization process can become frustrating and time-consuming for a user and can waste significant amounts of computing resources.

Aspects described herein may address these and other problems, and generally enable a user to be verified in a more reliable and robust manner, thereby improving the safety of financial accounts and computer transaction systems and the user experience during the authentication process.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to excluding transactions conducted by the related users from being presented to a user in an authentication question including one or more false merchant choices. For example, the user might not readily recall that whether she or her spouse purchased a dinner from a pizzeria. Including the name of the pizzeria in the authentication questions and asking the user to identify a false merchant choice based on her own transaction history may cause confusion and frustrate a legitimate user from accessing her account. Conversely, excluding such transactions may increase memorability, promote account accessibility to the users, and better protect their accounts from unauthorized access. As will be described in greater detail below, this process is effectuated by determining a relatedness between one or more groups of users using a machine learning model, which may be trained using account records related to numerous users including their transaction records. Based on the relatedness between a first user and a second user, a set of modified false merchant choices may be generated for the first user by excluding certain merchants with which the second user conducted a transaction within a time period. As such, the modified set of false merchant choices may be presented in an authentication question to minimize confusions and increase account accessibilities in the user community.

More particularly, and as will be described further herein, a computing device may train, using a history of account records by a plurality of different users, a machine learning model to determine a relatedness between one or more groups of users from the plurality of different users. The computing device may receive, from a user device, a request for access to a first account associated with a first user. The computing device may subsequently receive, from one or more databases, first account data corresponding to the first account, and second account data corresponding to a second account. The first account data may indicate one or more transactions conducted by the first user, and the second account data may indicate one or more transactions conducted by a second user. The computing device may provide, as input to the trained machine learning model, the first account data and the second account data. The computing device may receive, from the trained machine learning model, data indicating a relatedness between the first user and the second user. The computing device may determine, based on the one or more databases, a set of false merchant choices associated with the first user. Based on the data indicating the relatedness between the first user and the second user, the computing device may generate a modified set of false merchant choices by excluding one or more merchants with which the second user conducted a transaction using the second account within a predetermined time period. The computing device may generate an authentication question comprising at least one false merchant choice from the modified set of false merchant choices. The computing device may generate a correct answer to the authentication question based on the first account data and the modified set of false merchant choices. The computing device may provide the authentication question to the user device and receive a response to the authentication question. The computing device may compare the response to the authentication question to the correct answer, and grant the user device access to the first account based on the response to the authentication question matching the correct answer.

In many aspects, the computing device may train the machine learning model based on account profile information comprising a billing address, an emergency contact, a phone number, and/or an email address. The machine learning model may be trained to determine the relatedness between the pair of users based on the account profile information. The computing device may train the machine learning model based on transaction information comprising a transaction time and a transaction location. The machine learning model may be trained to determine the relatedness between the pair of users based on the transaction information. The computing device may train the machine learning model based on biometric information associated with the first user and the second user. The machine learning model may be trained to determine the relatedness between the pair of users based on the biometric information. The computing device may train the machine learning model based on social media information associated with the first user and the second user and the machine learning model may be trained to determine the relatedness between the pair of users based on the social media information.

In many aspects, the computing device may receive data indicating that the first user and the second user are associated with a same account or they are associated with different accounts with a financial institution. After determining that the first user is related to the second user, the computing device may determine that one or more accounts associated with the second user. The computing device may exclude, from the set of modified false merchant choices, the one or more merchants with which the second user conducted one or more transactions using the one or more accounts within the predetermined time period. In some examples, the one or more transactions conducted by the first user may correspond to a first set of merchants, and the one or more transactions conducted by the second user may correspond to a second set of merchants. As such, the set of modified false merchant choices might not include one or more merchants from the first set of merchants because the first set of merchants are the true merchants for the first user. The modified set of false merchant choices might not include one or more merchants in the second set of merchants with which the second user conducted a transaction within the predetermined time period, because these false merchants may potentially cause confusion to the first user.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for excluding transactions from related users in transaction-based authentication;

FIG. 5 depicts an example interface for a user to configure related users;

FIG. 6A illustrates illustrative false merchant choices; and

FIG. 6B depicts an example of an authentication question that may be presented to a user.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used during an authentication process. In particular, the process depicted herein may determine a set of false merchant choices related to a first user's transaction history. Certain false merchants may be excluded to generate a modified set of false merchant choices, because such false merchants may appear in transactions of a second user related to the first user. The relatedness between the first user and the second user may be determined based on transaction histories, account profile information, social media information or biometric information associated with the users. In this manner, authentication questions might be generated using the modified set of false merchant choices and presented in a manner which does not undesirably confuse a user. For example, the modified set of false merchant choices might not include any false merchants that the second user related to the first user has transacted with in a predetermined period of time. Due to the relatedness between the first user and the second user and/or recency of such transactions, the user may have a persistent memory of using a product or service procured from the merchants that, for example, a close family member or a roommate paid for. Including such false merchants in the authentication question might make it difficult for a legitimate user to identify them as false merchants. Conversely, excluding these potential confusing merchants may increase accessibility and promote security on the user accounts.

More particularly, some aspects described herein may provide for a computing device that may train the machine learning model based on account profile information comprising a billing address, an emergency contact, a phone number or an email address. The machine learning model may be trained to determine the relatedness between the pair of users based on the account profile information. The computing device may train the machine learning model based on transaction information comprising a transaction time and a transaction location. The machine learning model may be trained to determine the relatedness between the pair of users based on the transaction information. The computing device may train the machine learning model based on biometric information associated with the first user and the second user. The machine learning model may be trained to determine the relatedness between the pair of users based on the biometric information. The computing device may train the machine learning model based on social media information associated with the first user and the second user and the machine learning model may be trained to determine the relatedness between the pair of users based on the social media information.

In many aspects, the computing device may receive data indicating that the first user and the second user are associated with a same account or they have different accounts with a financial institution. After determining that the first user is related to the second user, the computing device may determine that one or more accounts associated with the second user. The computing device may exclude, from the set of modified false merchant choices, the one or more merchants with which the second user conducted one or more transactions using the one or more accounts within the predetermined time period. In some examples, the one or more transactions conducted by the first user may correspond to a first set of merchants, and the one or more transactions conducted by the second user may correspond to a second set of merchants. As such, the set of modified false merchant choices might not include one or more merchants from the first set of merchants, because the first set of merchants are the true merchants for the first user. The modified set of false merchant choices might not include one or more merchants in the second set of merchants with which the second user conducted the transaction within the predetermined time period, because these false merchants may potentially cause confusion to the first user.

Aspects described herein improve the functioning of computers by improving the accuracy and security of computer-implemented authentication processes. The steps described herein recite improvements to computer-implemented authentication processes, and in particular improve the accuracy and utility of authentication questions used to provide access to computing resources. This is a problem specific to computer-implemented authentication processes, and the processes described herein could not be performed in the human mind (and/or, e.g., with pen and paper). For example, as will be described in further detail below, the processes described herein rely on the processing of transaction data, the dynamic computer-implemented generation of authentication questions, and the use of various machine learning models.

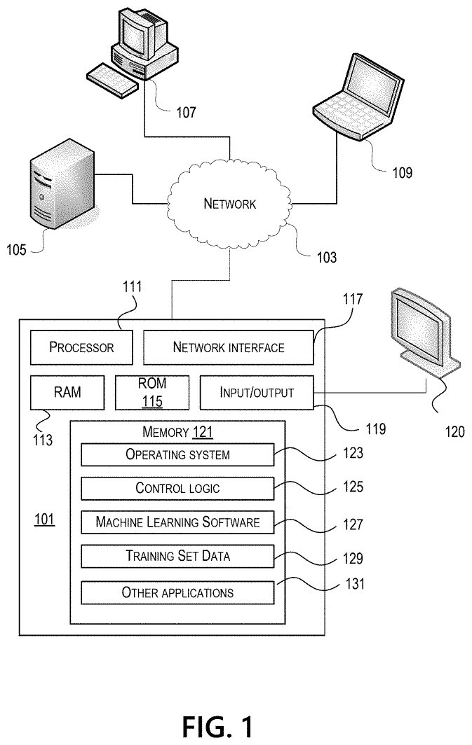

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

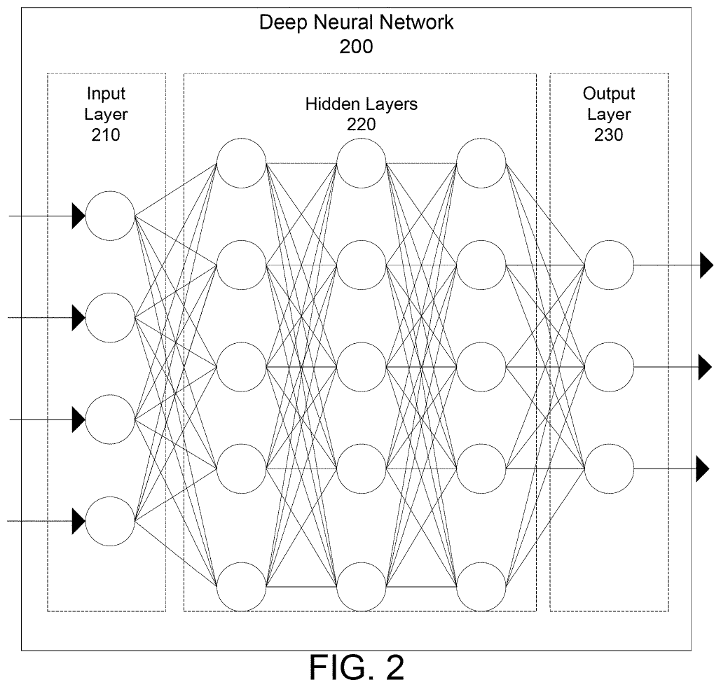

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

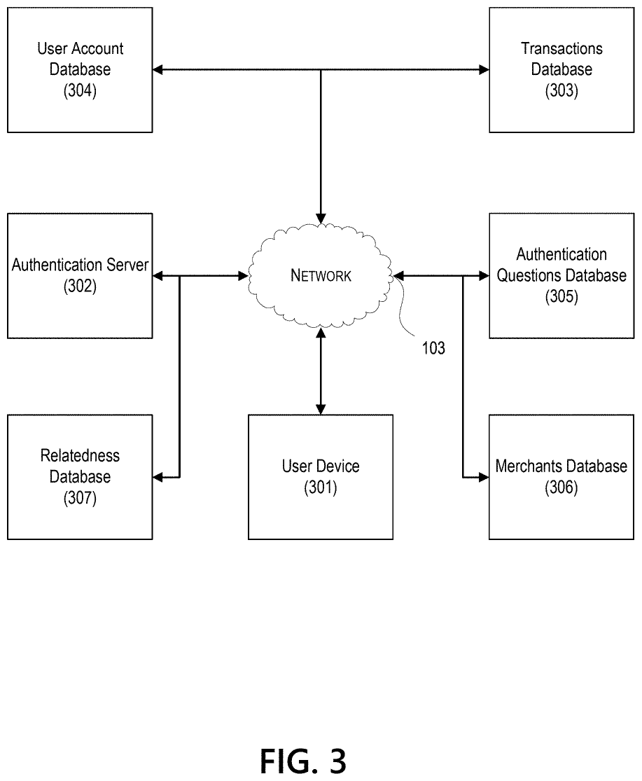

FIG. 3 depicts a system for authenticating a user device 301. The user device 301 is shown as connected, via the network 103, to an authentication server 302, a transactions database 303, a user account database 304, an authentication questions database 305, a merchants database 306 and a relatedness database 307. The network 103 may be the same or similar as the network 103 of FIG. 1. Each of the user device 301, the authentication server 302, the transactions database 303, the user account database 304, the authentication questions database 305, the merchants database 306, and/or the relatedness database 307 may be one or more computing devices, such as a computing device comprising one or more processors and memory storing instructions that, when executed by the one or more processors, perform one or more steps as described further herein. For example, any of those devices might be the same or similar as the computing devices 101, 105, 107, and 109 of FIG. 1.

As part of an authentication process, the user device 301 might communicate, via the network 103, to access the authentication server 302 to request access (e.g., to a user account). The user device 301 shown here might be a smartphone, laptop, or the like, and the nature of the communications between the two might be via the Internet, a phone call, or the like. For example, the user device 301 might access a website associated with the authentication server 302, and the user device 301 might provide (e.g., over the Internet and by filling out an online form) candidate authentication credentials to that website. The authentication server 302 may then determine whether the authentication credentials are valid. For example, the authentication server 302 might compare the candidate authentication credentials received from the user device 301 with authentication credentials stored by the user account database 304. In the case where the communication is telephonic, the user device 301 need not be a computing device, but might be, e.g., a conventional telephone.

The user account database 304 may store information about one or more user accounts, such as a username, password, a billing address, an emergency contact, a phone number, other demographic data about a user of the account, or the like. For example, as part of creating an account, a user might provide a username, a password, and/or one or more answers to predetermined authentication questions (e.g., “What is the name of your childhood dog?”), and this information might be stored by the user account database 304. The authentication server 302 might use this data to generate authentication questions. The user account database 304 might store demographic data about a user, such as her age, gender, billing address, occupation, education level, income level, and/or the like.

The transactions database 303 might comprise data relating to one or more transactions conducted by one or more financial accounts associated with a first organization. For example, the transactions database 303 might maintain all or portions of a general ledger for various financial accounts associated with one or more users at a particular financial institution. The data stored by the transactions database 303 may indicate one or more merchants (e.g., where funds were spent), a transaction amount spent (e.g., in one or more currencies), a transaction date and/or time (e.g., when funds were spent), or the like. The data stored by the transactions database 303 might be generated based on one or more transactions conducted by one or more users. For example, a new transaction entry might be stored in the transactions database 303 based on a user purchasing an item at a store online and/or in a physical store. As another example, a new transaction entry might be stored in the transactions database 303 based on a recurring charge (e.g., a subscription fee) being charged to a financial account. The data stored by the transactions database 303 might be related to a fund transfer from a user account to a second user account. The first user account and the second user account may be associated with the same financial institution. The first user account and the second user account may be associated with different financial institutions. For example, the second user may pay for a pizza dinner for both the first user and the second user because the first user and second user are roommates living together. The first user may pay her share of the dinner and transfer some fund from her bank account to the second user via an online payment method, such as via the ZELLE payment network by Early Warning Systems, LLC of Scottsdale, Ariz. The transactions database 303 may store recent (e.g., recurrent) transactions between the first user and the second user.

The account data stored by the user account database 304 and the transactions database 303 may, but need not be related. For example, the account data stored by the user account database 304 might correspond to a user account for a bank website, whereas the financial account data stored by the transactions database 303 might be for a variety of financial accounts (e.g., credit cards, checking accounts, savings accounts) managed by the bank. As such, a single user account might provide access to one or more different financial accounts, and the accounts need not be the same. For example, a user account might be identified by a username and/or password combination, whereas a financial account might be identified using a unique number or series of characters.

The authentication questions database 305 may comprise data which enables the authentication server 302 to present authentication questions. An authentication question may be any question presented to one or more users to determine whether the user is authorized to access an account. For example, the question might be related to personal information about the user (e.g., as reflected by data stored in the user account database 304), might be related to past transactions of the user (e.g., as reflected by data stored by the transactions database 303), or the like. The authentication questions database 305 might comprise data for one or more templates which may be used to generate an authentication question based on transaction information (e.g., from the user account database 304 and/or the transactions database 303). The authentication questions database 305 might additionally and/or alternatively comprise one or more static authentication questions, such as an authentication question that is used for a wide variety of users (e.g., “What is your account number?”). An authentication question might correspond to a transaction occurred or not occurred in the past. The authentication questions database 305 might additionally and/or alternatively comprise historical authentication questions. For example, the authentication questions database 305 might comprise code that, when executed, randomly generates an authentication question, then stores that randomly-generated authentication question for use with other users.

The authentication questions stored in the authentication questions database 305 may be associated with varying levels of difficulty. Straightforward questions that should be easily answered by a user (e.g., “What is your mother's maiden name?”) might be considered easy questions, whereas complicated answers that require a user to remember past transactions (e.g., “How much did you spend on coffee yesterday?”) might be considered difficult questions. The authentication questions stored in the authentication questions database 305 may be associated with varying levels of memorability and guessability. Including one or more false merchant choices in the authentication questions may promote memorability, given that a legitimate user may readily identify a merchant if she does not shop at that merchant in a predetermined period of time. Excluding certain false merchants corresponding to transaction conducted by related users may minimize confusion and increase the security of the user accounts.

The merchants database 306 might store data relating to one or more merchants, including the false merchant choices for the users. The merchants database 306 may be a merchant database that stores enterprise merchant intelligence records, which may in turn include a merchant identifier, a friendly merchant name, a zip code, a physical address, a phone number, an email or other contact information of the merchants, or a merchant category code (MCC). A MCC may be a four-digit number listed in ISO 18245 for retail financial services and used to classify a business by the types of goods or services it provides. MCCs may be assigned either by merchant type (e.g., one for hotels, one for office supply stores, etc.) or by merchant name. For example, grocery stores are classified as MCC 5411, “Grocery Stores, Supermarket,” convenient stores are classified as MCC No. 5499, “MISC Food Stores—Default.” The merchant records may be collected from public resources or merchant reported records.

A financial organization may build a proprietary version of the merchants database 306, for example, based on an aggregation of transaction records in transactions database 303. As a transaction arrives from a transaction stream, the corresponding transaction record may be processed, cleaned, and/or enhanced with a variety of services. For example, when a financial institution receives the transaction information in a transaction stream, the transaction information may be in the form of a line of data that offers limited information about the transaction, with each piece of information appearing in certain locations within the line of data. The merchant identifier may appear in a specific location and may include 8-10 characters in the abbreviated form, which might not be readily recognizable as a meaningful merchant name, particularly for small business merchants. The financial institution may process this abbreviated merchant identifier and convert it into a meaningful merchant name in a human readable format, and store it in the merchants database 306.

A financial organization may use a third-party API to gather merchant information, such as a merchant address or contact information, to be stored in the merchants database 306. A financial organization may maintain more static merchant information, such as a merchant identifier and MCC, in its proprietary the merchants database 306. A financial institution may use the third-party API to get merchant address, merchant social media handle, or other merchant information that may change over time.

The data stored by the merchants database 306 might be used to generate authentication questions that comprise both correct answers (e.g., based on data from the transactions database 303 indicating one or more real merchants with which a user has conducted a transaction) and false answers (e.g., based on data from the merchants database 306, which might be randomly-selected merchants where a user has not or rarely conducted a transaction). For example, a computing device may receive from merchants database 306 indications (e.g., merchant names, merchant identifiers) of different merchants. The computing device may further receive transaction data from transaction database 303 indicating one or more transactions conducted by a user. The computing device may determine one or more false merchants related to a user and store a list of the false merchant choices in the merchants databases 306. The list of the false merchant choices may be further modified by excluding certain merchants corresponding to transactions of related users. For example, the related users may be a spouse, a child, a family member, or other co-inhabitant with the user (e.g., a roommate) that may share some expenses. As such, an authentication question may be generated based on the modified false merchant choices.

The relatedness database 307 may store data corresponding to relatedness between users. The computing device may determine that two or more users are related to each other based on account data associated with the users. The account data may include account profile information such as a billing address, an emergency contact, an email address, and/or other information indicating the users may be in a same household. For example, if two users share a same billing address or email address, this may be a strong indication that the users are related to each other. As another example, if two users share a same emergency contact or they are each other's emergency contact, this may be an indication that the users are related to each other and their transactions may overlap. The related databased 307 may store a data record including a first user identifier, a second user identifier, and their relatedness (e.g., via a common billing address). The related databased 307 may also store a score in the data record indicating how strong the relatedness between two users.

The account data may indicate that the first user may be a primary user or an account holder of an account, and the second user may be a secondary user of the account. The account data may indicate that the first user is an account holder of one or more first accounts, and the second user may be an account holder of one or more second accounts. The first accounts and second accounts may or might not overlap with each other.

The computing device may determine that one or more groups of users are related to each other based on transaction information associated with the users. The transaction information may indicate recurrent transactions between the users. For example, if a first user regularly sends payment or receives payment from a second user, this may indicate that the users frequently interact with each other and share expenses. The computing device may set a threshold that if the first user receives payment from the second user for a threshold number of times or a threshold amount within a predetermined period of time (e.g., monthly), the relatedness between the users may be established. The relatedness may be, for example, a co-inhabitation situation that the two roommates regularly share expenses for a meal, a utility bill, a cable service, etc. The related databased 307 may store a data record including a first user identifier, a second user identifier, and their relatedness (e.g., via recurrent payments to each other).

The computing device may determine that one or more groups of users are related to each other based on social media information associated with the users. Social media information may be retrieved from one or more social media platforms and used to determine, e.g., familial and/or friendship relationships between users. For example, the social media information may be used to verify the relatedness of the users, after the initial relatedness is determined using other approaches. The social media information may indicate the locations of the users, the social events they attend together, their common friends, etc. For example, if the users are regularly tagged together in photos related to some social events, or they regularly share locations indicating they appear in the same location at the same time. The social media information may further indicate that they share the same family name, or attend the same school simultaneously. The computing device may extract the names of the users and identify the corresponding financial accounts associated with these users. The social information may be used to verify whether the users are related to each other. The relatedness may be, for example, a co-inhabitation situation that the two roommates regularly share expenses, two family members paying for each other's bill, or a dating situation that the two users might not live together but share expenses regularly. The related database 307 may store a data record including a first user identifier, a second user identifier, and their relatedness (e.g., via social media information).

The computing device may determine that one or more groups of users are related to each other based on biometric information associated with the users. The biometric information may include biometric identifiers that may indicate association of the users. For example, deoxyribonucleic acid (DNA) information may indicate a familial relationship among users. The related databased 307 may store a data record including a first user identifier, a second user identifier, and their relatedness (e.g., via familial association).

The computing device may train a machine learning model to determine a relatedness between one or more groups of users. The computing device may provide, as input to the trained machine learning model, account data associated with one or more groups of users. The computing device may receive, from the trained machine learning model, data indicating a relatedness between a first user and a second user. The machine learning model may be trained to determine the relatedness between two users. The machine learning model may be trained using tagged training data indicating whether the users are related along with training data such as their profile information, transaction information, etc. As such, the machine learning model may determine what types of patterns in, for example, the profile information and transaction information may suggest relatedness between the users. The training data may include factors (e.g., one or more data points in the training data) such as a history of account records including account profile information (e.g., billing addresses, emergency contacts, phone numbers, email addresses) associated with the users, the transaction information, social media information or biometric information associated with the users. The machine learning model may be trained to assign appropriate weight to each factor to determine a score indicating the relatedness between one or more groups of users. The trained machine learning model may generate an output whether the users are related to each other based on the score.

Having discussed several examples of computing devices which may be used to implement some aspects as discussed further below, discussion will now turn to a method for excluding transactions from related users in transaction-based authentication.

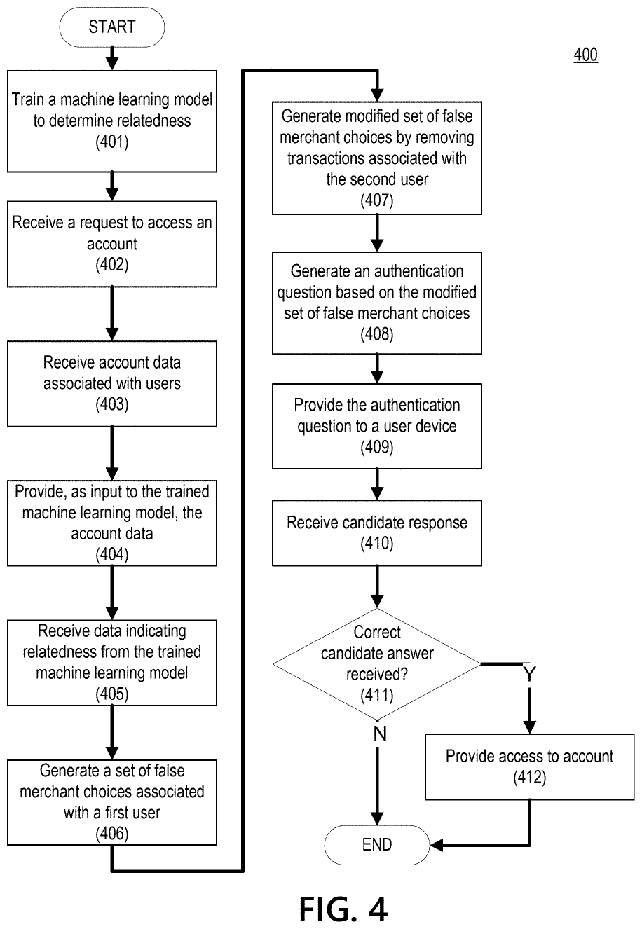

FIG. 4 illustrates an example method 400 for excluding transactions from related users in transaction-based authentication in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, a computing device (e.g., authentication server 302) may train a machine learning model to determine a relatedness between two or more users from a plurality of different users. The machine learning model (e.g., as implemented via the deep neural network 200 and/or the machine learning software 127) may be trained using a history of account records by the plurality of different users, who have one or more accounts with a financial institution. For example, the account records may include account profile information such as billing addresses, emergency contacts, email addresses, phone numbers, or other information indicating one or more groups of users may be in a same household. To train the machine learning model in this manner, the machine learning model may be provided with account profile information for various accounts associated with the plurality of different users. For example, the computing device may process the account records and extract the corresponding billing address, emergency contact, email address, phone number for each of the plurality of users. Based on the billing addresses, emergency contacts, email addresses, phone numbers, etc., the machine learning model may be trained to determine predicted relatedness associated with these different users. For example, the machine learning model may be trained to determine that a first user and a second user share a same billing address or an email address, this may be a strong indication that the two users are related to each other. If two users share a same emergency contact or they are each other's emergency contact, this may be an indication that the users are related to each other and their transactions may overlap. Based on these commonalities in their account records, the machine learning model may determine a score indicating the strength of the relatedness. For example, if two users share a same billing address, the machine learning model may assign a high score to indicate a strong relatedness.

The machine learning model may be trained to identify the relatedness of two or more users based on information such as transaction information of different users. For example, the machine learning model may be provided tagged training data that indicates that two users are related when those users regularly exchange small quantities of money via online methods (to, e.g., reimburse one another for their portions of group meals). After all, if a first user regularly sends payment to or receives payment from a second user, this may indicate that the users frequently interact with each other and share expenses. The machine learning model may, based on the training data, set a threshold for relatedness: for example, if a first user receives payment from a second user a threshold number of times and/or if a first user receives payment of a threshold amount from a second user within a predetermined period of time (e.g., monthly), the machine learning model may be trained to output an indication that the two users re related. This relation might reflect, for example, the fact that the two users live together, such as in the case of two roommates that regularly share expenses for a meal, a utility bill, a cable service, etc. In some examples, the first user may regularly send payments to the second user via a third-party service such as Zelle. The machine learning model may extract, for example, a phone number or an email address of the recipient of the payment. If there is a common phone number or a common email address between the sending and recipient accounts, this may be a further indication that the two users may be related and their transactions may overlap.

The machine learning model may be trained to identify the relatedness of two or more users based on other transaction information, such as a common transaction pattern. For example, the transaction information may include transactions from one or more groups of users that occur approximately the same time. The machine learning model may be provided tagged training data that indicates transactions from the users may occur at the same merchants or at different merchants. For example, two users may frequently split a bill at a favorite restaurant. The transaction information may include payment to the same restaurant at approximately the same time. In another example, it might be common for users to first buy an admission ticket for an amusement park, then buy food at the amusement park. If user 1 buys the tickets and user 2 buys the food, they might be related because, e.g., user 1 might have bought a ticket for user 2. The machine learning model may be trained to identify the repeated pattern of transactions occurred close to each other between these two user accounts. The machine learning model may determine that the two users may be related to each other and their transactions may overlap.

The machine learning model may be trained to determine the relatedness of two or more users based on social media information associated with the users. For example, the machine learning model may be provided training data that includes social media information, which may be used to verify the relatedness of the users, after the initial relatedness is determined using other approaches. The social media information may indicate the locations of the users, the social events they attend together, or their common friends, etc. For example, the two or more users may be regularly tagged together in photos related to various social events, or they may regularly share locations indicating they appear in the same location at the same time. The social media information may further indicate that they share the same family name, or attend the same school simultaneously. The machine learning model may extract the names of the users and identify the corresponding financial accounts associated with these users. The social information may be used to verify whether the users are related to each other. Based on the training data including the social media information, the machine learning model may be trained to output an indication that the two users are related. The relatedness may reflect, for example, a co-inhabitation situation that the two roommates regularly share expenses, some family members paying for each other's bill, or a dating situation that the two users might not live together but frequently share expenses.

The machine learning model may be trained to determine the relatedness of two or more users based on biometric information associated with two or more users. The biometric information may include biometric identifiers that may indicate association of the users. For example, the DNA information may indicate a familial relationship among users. Due to privacy or compliance concerns, the machine learning model might not have access to all the information discussed above.

The machine learning model may be trained to determine the relatedness based on a combination of factors associated with the account profile information, the transaction information, the social media information and the biometric information. The computing device may use one or more factors in a collection of factors to train the machine learning model. The machine learning model may be provided tagged training data that indicates that two users are related and the collection of factors. The machine learning model may initially assign a weight to each factor in the collection. For example, the machine learning model may assign a first weight to a factor in the social media information (e.g., one or more groups of users are tagged in a same picture), and a second weight to a transaction time in the transaction information. The first weight may be lower than the second weight. Given that if two users have conducted transactions close to each other, this is more indicative of overlapping transactions than the situation that the users merely appeared together in a picture. For strong indicators, such as a billing address, the machine learning model may assign a weight, for example, three times as high as a random factor in the social media information. The machine learning model may be trained to output an indication that the users are related to each other based on the weights. The weights may be adjusted and tuned based on other factors in the collection. The machine learning model may go through several iterations to assign different weights to different factors. The machine learning model may be trained with the appropriate weights for the factors. The trained machine learning model may be trained to output an indication the users are related to each other based on the appropriate weights.

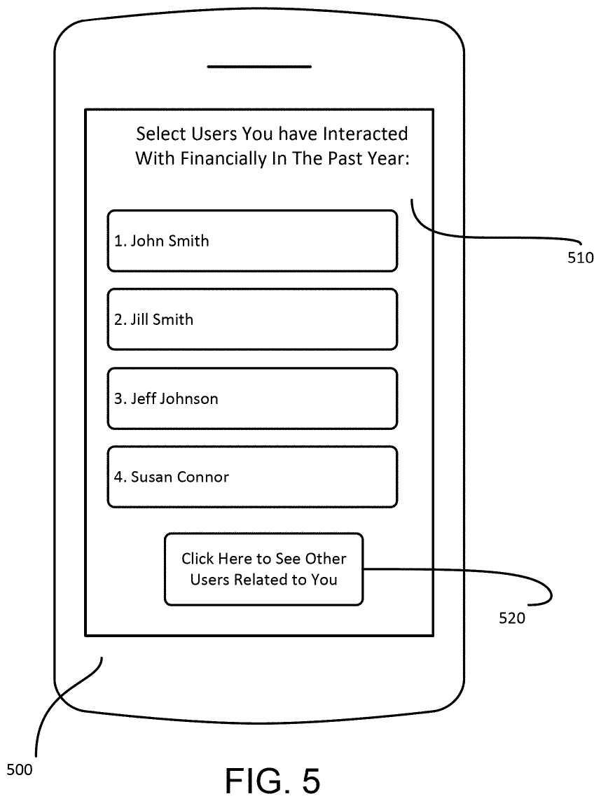

The machine learning model may be trained using feedback from users. FIG. 5 depicts example interfaces for a user to configure related users. As illustrated in FIG. 5, the computing device may present to a user an interface 510 on a user device 500 with a list of other users that may be related to a user. The computing device may initially recommend a list of users based on the account records or transaction information of the users in the past year. For example, the computing device may present a plurality of users that a first user has recurrent payment information in the past year. The user may select one or more related users from a list comprising, for example, John Smith, Jill Smith, Jeff Johnson, and Susan Connor. The computing device may receive a response from the user for a selection of the one or more users (e.g., John Smith) as the related users. In one example, the user may select John Smith (spouse), Jill Smith (child), and Jeff Johnson (lunch buddy), as the related users. The computing device may ask a user to provide a ranking (not shown in FIG. 5) of the related users, depending on how frequently the user interacts with the related users financially. For example, the user may rank John Smith (10), Jill Smith (8) and Jeff Johnson (5). The user might not select Susan Connor, who is a friend that the user did not see her in the past year due to a pandemic. The computing device may provide the user feedback as tagged training data to train the machine learning model. The machine learning model may be trained to output one or more indications that the user is related to John Smith, Jill Smith and Jeff Johnson. The machine learning model may be trained to output an indication that the user is not related to Susan Connor.

In step 402, the computing device may receive, from a user device, a request for access to an account associated with a user. The request may be associated with access, by a user, to a website, an application, or the like. The request may additionally and/or alternatively be associated with, for example, a user device calling into an Interactive Voice Response (IVR) system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user might call an IVR system and be identified (e.g., using caller ID) by their telephone number, which might be used to query the user account database 304 for a corresponding account.

In step 403, the computing device may receive, from one or more databases, account data corresponding to a first account and a second account. The account data may indicate one or more transactions conducted by a first user and a second user. The account data may be received from, e.g., the transactions database 303. For example, the transactions data may comprise transaction data related to purchases of goods and/or services made by the users. The transactions data might correspond to a period of time, such as a recent period of time (e.g., the last two months, the last four months, or the like). The transaction data may also indicate whether the first user or the second user conducted one or more transactions with a particular merchant.

The account data may indicate account profile information. The account profile information may be received from, e.g., the user account database 304. For example, the account data may comprise account profile information related to, such as a billing address, an emergency contact, a phone number or an email address. The account data may also indicate demographic data about the user such as age, gender, location, occupation, education level, income level, etc.

The account data may indicate social media information. The social media information may be retrieved as unstructured data from various sources, such as the body of an e-mail message, Web page, or word-processor document. For example, the computing device may extract content and/or data from a social media website automatically using a bot, web scraper, etc. The computing device may access the social media website using the Hypertext Transfer Protocol (HTTP), or through a web browser. The computing device may copy and/or collect unstructured data in a text format from the web, convert the social media information into a common format, such as a JSON format or an XML format. The computing device may store the social media information in a social media database for later retrieval and/or analysis.

The account data may indicate biometric information associated with the users. The biometric information may include body measurements and calculations related to human characteristics such as fingerprint, palm veins, face recognition, DNA, palm print, hand geometry, iris recognition, retina analysis, and/or odor/scent analysis. The biometric information may also include behavioral characteristics such as typing rhythm, gait, keystroke, signature, behavioral profiling, and voice. Some biometric information, such as DNA may indicate a familial relationship among the users. The computing device may retrieve the biometric information from various sources, which may include books, journals, documents, metadata, health records, audio, video, analog data, images, files, or the like. The computing device may store the biometric information in a biometric database for later retrieval and/or analysis.

In step 404, the computing device may provide, as input to the trained machine learning model, the account data corresponding to the first account and the second account. The input to the trained machine learning model may include transaction data related to one or more transactions conducted by the first user and the second user, such as the recurrent payments between the two users, or transaction date, transaction amount and merchant information corresponding to the transactions. The input may include account profile information, the social media information or the biometric information associate with the two users.

In step 405, the computing device may receive, from the trained machine learning model, an output indicating a relatedness between the first user and the second user. The trained machine learning model may output a Boolean value, such as a value of “true” for related and “false” for unrelated. The trained machine learning model may output a score for each factor and a corresponding weight for each factor associated with the account data. The account data may include factors (e.g., one or more data points in the account data) such as a history of account records including account profile information (e.g., billing addresses, emergency contacts, phone numbers, email addresses) associated with the users, the transaction information, social media information or biometric information associated with the users. Based on the account data and the corresponding weights for different factors in the account data, the trained first machine learning model may generate data indicating the relatedness of the first user and the second user. For example, the trained machine learning may calculate an aggregated score indicating the relatedness between the first user and the second user based on factors including recurrent payments between the users (e.g., frequencies and total payment amount), the co-appearance in a social event, and a common phone number (e.g., a land phone number) that appear in the accounts of the first user and the second users, and the corresponding weights for these factors. Each factor may be assigned a score by the trained machine learning model. The trained machine model may generate an aggregated score based on an aggregation of the scores and weights on the factors. If the aggregated score is above a threshold value (e.g., 50 points), the first user may be related to the second user. Otherwise, the first user might not be related to the second user.

In step 406, the computing device may determine a set of false merchant choices associated with the first user. The false merchant choices may be generated based on the transaction history of the first user in a predetermined period of time. If the user has multiple accounts with a financial institution, the computing device may look at the transaction history of multiple accounts associated with the first user. For example, the transaction records may indicate the first user has not transacted with Joe's Grocery, Oceanview Seafood, SuperH Liquor Store, Uncle K's and ABC Market in the past year.

In step 407, the computing device may generate a modified set of merchant choices associate with the first user by excluding one or more merchants with which the second user conducted a transaction using the second account within a predetermined time period. The computing device may generate a list of merchants that the second user has transacted with in the predetermined period of time based on a transaction history of the second user. If the second user has multiple accounts with the financial institution, the computing device may look at the transaction history of the multiple accounts. The computing device may generate a list of merchants that the second user has transacted with in the past year. Due to the relatedness of the first user and the second user, the first user may use a product or service provided by this list of merchants and purchased by the second user, even though the first user did not pay for the product or service directly using her account. For example, the first user and the second user may be roommates in an apartment complex that share expenses. The first user paid for a pizza order from a pizzeria, while the second user paid for a taco dinner at Uncle J's. The first user may recall that she had the taco dinner, but might not readily recall whether she is the one actually paid for Uncle J's. Even though the first user did not pay for the taco dinner, seeing Uncle J's on the set of false merchant choices may be confusing to the first user. As such, the set of false merchant choices for the first user may be modified to exclude or remove merchants that the second user has transacted with in the past year. The modified set of false merchant choices may therefore be a subset of the initial set of false merchant choices.

The computing device may use the trained machine learning model to identify a plurality of users that are related to the first user. For example, the computing device may provide to the trained machine learning model, a plurality of account data associated with the plurality of users including the first user. The computing device may receive from the trained machine learning model data indicating a relatedness between the first user and one or more other users. For example, based on the data indicating the relatedness, the computing device may determine that the first user is related to a second user who is a spouse of the first user, a third user who is a child of the first user that also lives in the same household, and a third user who is a lunch buddy that frequently share lunch expenses with the first user.

The computing device may determine a first set of accounts associated with the first user, a second set of accounts associated with the second user (e.g., a spouse), a third set of accounts associated with the third user (e.g., a child) and a fourth set of accounts associated with the fourth user (e.g., a lunch buddy). The first set of accounts may overlap with the second set of accounts. For example, the first user and the second user (e.g., a spouse of the first user) may share some accounts together. The second user may additionally hold some unique accounts that do not involve the first user. The computing device may determine a second set of merchants that the second user has transacted with using these unique accounts in a predetermined period of time (e.g., a month, a quarter, or a year). The computing device may exclude or remove the second set of merchants from the false merchant choices for the first user.

Likewise, the third set of accounts may include one or more accounts shared by the first user and the third users (e.g., a child of the first user). The third user might not hold any unique accounts that do not involve the first user. The computing device may determine a third set of merchants that the third user has transacted in the predetermined period of time. Due to the relatedness between the first user and the third user (e.g., parent-child relationship) and the third set of merchants are also true merchants in the first user's transaction history, the computing device may ignore the third set of merchants. There is no need to exclude the third set of merchants from the false merchant choices for the first user.

Conversely, the first user and the fourth user (e.g., a lunch buddy of the first user) might not share any accounts together. The fourth user may hold a plurality of accounts that do not involve the first user. The computing device may determine a fourth set of merchants that the fourth user has transacted with using these plurality of accounts in the predetermined period of time. The computing device may exclude or remove the fourth set of merchants from the false merchant choices for the first user. As such, the modified false merchant choices may be generated by excluding or removing the second set of merchants and the fourth set of merchants from the initial false merchant choices for the first user.

In step 408, the computing device may generate, based on the modified false merchant choices, an authentication question for the first user. The authentication question may ask the first user, for example, whether she has made a purchase at one or more merchants from the modified false merchant choices.

In step 409, the computing device may present the authentication question. Presenting the authentication question may comprise causing one or more computing devices to display and/or otherwise output the authentication question. For example, the computing device may cause presentation, to the user, of the authentication question. Such presentation might comprise providing the authentication question in a text format (e.g., in text on a website), in an audio format (e.g., over a telephone call), or the like.

In step 410, the computing device may receive a candidate response to the authentication question. A candidate response may be any indication of a response, by a user, to the authentication question presented in step 409. For example, where an authentication question comprises a candidate merchant, the candidate response might comprise a selection of true or false for the candidate merchant. As another example, in the case of a telephone call, the candidate response might comprise an oral response to an authentication question provided using a text-to-speech system over the call.

In step 411, the computing device may determine whether the candidate answer received in step 410 is correct. Determining whether the candidate answer is correct may comprise comparing the answer to the correct answer determined as part of generating the authentication question in step 408. If the candidate answer is correct, the method 400 proceeds to step 412. Otherwise, the method 400 ends.

In step 412, the computing device may provide access to the account. For example, the computing device may provide, based on the candidate response, the user device access to the account. Access to the account might be provided by, e.g., providing a user device access to a protected portion of a website, transmitting confidential data to a user device, allowing a user to request, modify, and/or receive personal data (e.g., from the user account database 304 and/or the transactions database 303), or the like. In some examples, the computing device may provide the user access to the account when the candidate response is, for example, 100% accurate. Alternatively, or additionally, the computing device may provide the user access to the account based on the user has answered a threshold number of questions correctly (e.g., above 90%).

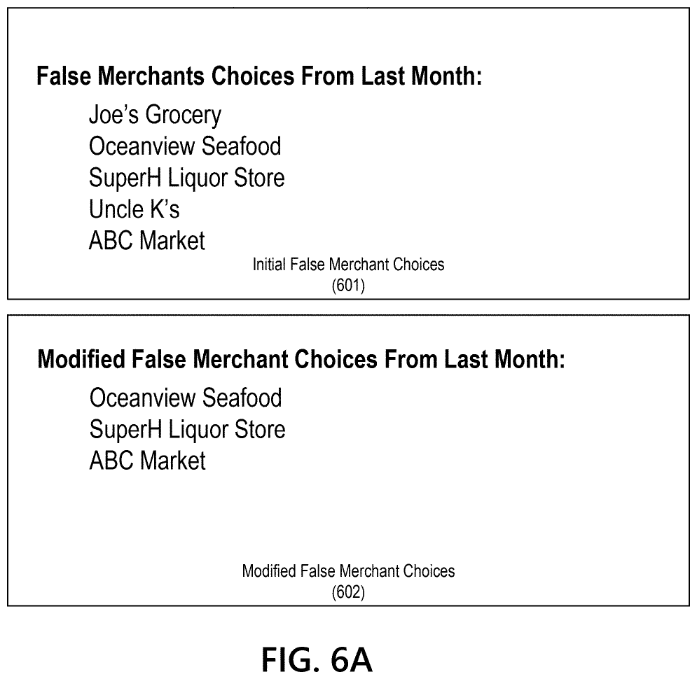

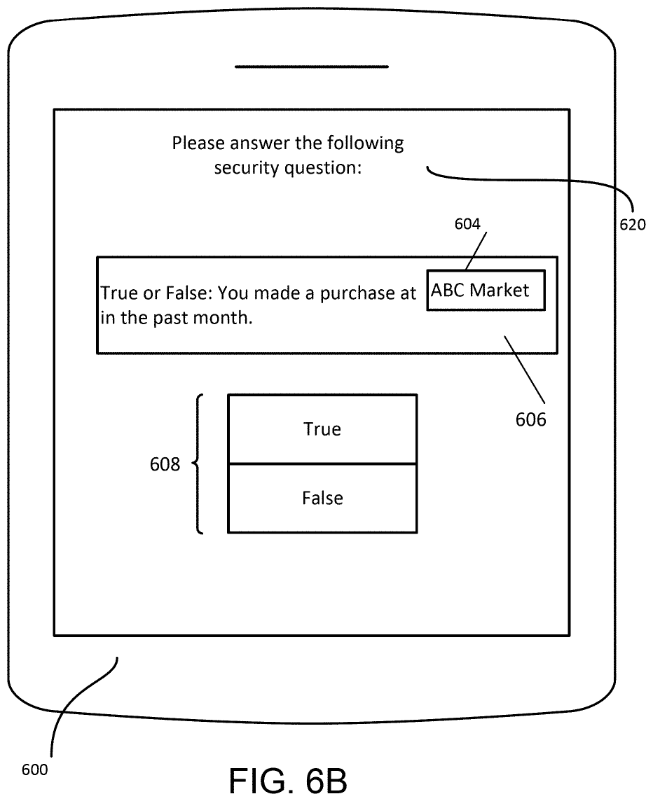

FIGS. 6A-B illustrate an example of generating an authentication question that may be presented to a user. The elements in FIGS. 6A-B are representations of various steps in the method 400 depicted in FIG. 4, such as those depicted with respect to steps 406 through 409 of the method 400. As illustrated in FIG. 6A, the computing device (e.g., authentication server 302) may determine initial false merchant choices for a user based on the user's transaction history. The false merchant choices might not be a merchant with which the user conducted a transaction with in, for example, the past 30 days using the user's accounts (e.g., a “false answer” merchants may be a merchant where the user did not conduct a transaction using the user's financial accounts). The computing device may determine the initial false merchant choices 601 for a user in a predetermined time period, e.g. the last month. The initial false merchant choices 601 may include Joe's Grocery, Oceanview Seafood, SuperH Liquor Store, Uncle K's and ABC Market. The computing device may determine that the first user has not transacted with any of the merchant in the initial false merchant choices 601 in the last month. The computing device may generate modified false merchant choices 602 by excluding or removing the merchants that one or more related users have transacted with in the last month. The computing device may determine, using a trained machine learning model, the user is related to one or more other users. The computing device may determine the user is related to one or more other users without using a trained machine learning model. For example, the computing device may determine that second user (e.g., a spouse of the first user) is related to the first user based on a common billing address and the second user has transacted with Joe's Grocery in the last month. Even though the first user did not shop at Joe's Grocery in the last month, she may see a shopping bag with Joe's Grocery logo at home. This may be potentially confusing for she if she did not recall whether she paid for the grocery with her credit card or her spouse paid for it using his separate card. The computing device may remove the potentially confusing merchant Joe's Grocery from the initial false merchant choices for the first user. The computing device may determine that a third user (e.g., a lunch buddy of the first user) is related to the first user using a trained machine learning model and based on the users' transaction history. The third user has transacted with Uncle K's in the last month. The first user may remember that she had lunch with the third user at Uncle K's, but she might not readily remember whether she paid for the lunch at Uncle K's for both of them, as they usually share lunch expenses at different occasions. The computing device may remove the potentially confusing merchant Uncle K's from the initial false merchant choices for the first user. It is also possible that the first user did not have lunch with the third user at Uncle K's and the third user paid for his own lunch on that day. To minimize confusion and reduce authentication failure for a legitimate user, the computing device may take an approach to be overly exclusive and still remove Uncle K's from the initial false merchant choices for the first user. After the computing device exclude or remove the transactions from related users (e.g., the second and third users), the modified false merchant choices 602 include a subset of the initial choices: Oceanview Seafood, SuperH Liquor Store and ABC Market.

The authentication question 620 may be generated and presented on user device 600 in FIG. 6B based on the described herein for reducing confusion and increasing memorability with respect to presented false merchant choices. For purposes of illustration, the authentication question 620 is illustrated as an authentication question based on modified false merchant choices 602 in FIG. 6A. The authentication question 620 may include a prompt 606. The prompt may include a merchant identifier 604. The authentication question 620 may further include a set of possible answers 608 (e.g., a manner for the user to answer True (“T”) or False (“F”) in response to the prompt 606). The authentication question 620 may be generated based on the modified false merchant choices 602. By generating the authentication question 620 based on the modified false merchant choices 602, the computing device may avoid presenting an authentication question that may confuse the user by excluding data (e.g., a merchant name) related to transactions from related users.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device comprising:
one or more processors; and
memory storing instructions that, when executed by the one or more processors, cause the computing device to:
train, using a history of account records by a plurality of different users, a machine learning model to determine a relatedness between a pair of users from the plurality of different users;
receive, from a user device, a request for access to a first account associated with a first user;
receive, from one or more databases, first account data corresponding to the first account, wherein the first account data indicates one or more transactions conducted by the first user;
receive, from the one or more databases, second account data corresponding to a second account, wherein the second account data indicates one or more transactions conducted by a second user;
provide, as input to the trained machine learning model, the first account data and the second account data;
receive, from the trained machine learning model, data indicating a relatedness between the first user and the second user;
determine, based on the one or more databases, a set of false merchant choices associated with the first user;
generate, based on the data indicating the relatedness between the first user and the second user, a set of modified false merchant choices by excluding one or more merchants with which the second user conducted a transaction using the second account within a predetermined time period;
generate an authentication question comprising at least one false merchant choice from the modified set of false merchant choices;
generate, based on the first account data and the modified set of false merchant choices, a correct answer to the authentication question;
provide the authentication question to the user device;
receive, from the user device, a response to the authentication question;
compare the response to the authentication question to the correct answer; and
grant the user device access to the first account based on the response to the authentication question matching the correct answer.

2. The computing device of claim 1, wherein the instructions, when executed by the one or more processors, cause the computing device to:
train the machine learning model based on account profile information comprising a billing address, an emergency contact, a phone number, or an email address; and
determine the relatedness between the pair of users based on the account profile information.

3. The computing device of claim 1, wherein the instructions, when executed by the one or more processors, cause the computing device to:
train the machine learning model based on transaction information comprising recurrent payment information; and
determine the relatedness between the pair of users based on the transaction information.

4. The computing device of claim 1, wherein the instructions, when executed by the one or more processors, cause the computing device to:
train the machine learning model based on biometric information associated with the first user and the second user; and
determine the relatedness between the pair of users based on the biometric information.

5. The computing device of claim 1, wherein the instructions, when executed by the one or more processors, cause the computing device to:
train the machine learning model based on social media information associated with the first user and the second user; and
determine the relatedness between the pair of users based on the social media information.

6. The computing device of claim 1, wherein the instructions, when executed by the one or more processors, cause the computing device to:
receive data indicating that the first user and the second user are associated with a same account.

7. The computing device of claim 1, wherein the instructions, when executed by the one or more processors, cause the computing device to:
after determining that the first user is related to the second user, determine, from the one or more databases, one or more accounts associated with the second user; and
exclude, from the set of modified false merchant choices, the one or more merchants with which the second user conducted one or more transactions using the one or more accounts within the predetermined time period.

8. The computing device of claim 1, wherein:
the one or more transactions conducted by the first user correspond to a first set of merchants,
the one or more transactions conducted by the second user correspond to a second set of merchants, and
the set of modified false merchant choices do not include one or more merchants from the first set of merchants.

9. The computing device of claim 8, wherein the modified set of false merchant choices do not include one or more merchants in the second set of merchants with which the second user conducted the transaction within the predetermined time period.

10. A method comprising:
training, using a history of account records by a plurality of different users, a machine learning model to determine a relatedness between a pair of users from the plurality of different users;
receiving, from a user device, a request for access to a first account associated with a first user;
receiving, from one or more databases, first account data corresponding to the first account, wherein the first account data indicates one or more transactions conducted by the first user;
receiving, from the one or more databases, second account data corresponding to a second account, wherein the second account data indicates one or more transactions conducted by a second user;
providing, as input to the trained machine learning model, the first account data and the second account data;
receiving, from the trained machine learning model, data indicating a relatedness between the first user and the second user;
determining, based on the one or more databases, a set of false merchant choices associated with the first user;
generating, based on the data indicating the relatedness between the first user and the second user, a set of modified false merchant choices by excluding one or more merchants with which the second user conducted a transaction using the second account within a predetermined time period;
generating an authentication question comprising at least one false merchant choice from the modified set of false merchant choices;
generating, based on the first account data and the modified set of false merchant choices, a correct answer to the authentication question;
providing the authentication question to the user device;
receiving, from the user device, a response to the authentication question;
comparing the response to the authentication question to the correct answer; and
granting the user device access to the first account based on the response to the authentication question matching the correct answer.

11. The method of claim 10, wherein training the machine learning model comprises:
train the machine learning model based on account profile information comprising a billing address, an emergent contact, a phone number, or an email address; and
determining the relatedness between the pair of users based on the account profile information.

12. The method of claim 10, wherein training the machine learning model comprises:
training the machine learning model based on transaction information comprising recurrent payment information; and
determining the relatedness between the pair of users based on the transaction information.

13. The method of claim 10, wherein training the machine learning model comprises:
training the machine learning model based on biometric information associated with the first user and the second user; and
determining the relatedness between the pair of users based on the biometric information.

14. The method of claim 10, wherein training the machine learning model comprises:
training the machine learning model based on social media information associated with the first user and the second user; and
determining the relatedness between the pair of users based on the social media information.

15. The method of claim 10, further comprising:
after determining that the first user is related to the second user, determining, from the one or more databases, one or more accounts associated with the second user; and
excluding, from the set of modified false merchant choices, the one or more merchants with which the second user conducted one or more transactions using the one or more accounts within the predetermined time period.

16. One or more non-transitory computer-readable media storing instructions that, when executed by one or more processors, cause a computing device to:
train, using a history of account records by a plurality of different users, a machine learning model to determine a relatedness between a pair of users from the plurality of different users;
receive, from a user device, a request for access to a first account associated with a first user;
receive, from one or more databases, first account data corresponding to the first account, wherein the first account data indicates one or more transactions conducted by the first user;
receive, from the one or more databases, second account data corresponding to a second account, wherein the second account data indicates one or more transactions conducted by a second user;
provide, as input to the trained machine learning model, the first account data and the second account data;
receive, from the trained machine learning model, data indicating a relatedness between the first user and the second user;
determine, based on the one or more databases, a set of false merchant choices associated with the first user;
generate, based on the data indicating the relatedness between the first user and the second user, a set of modified false merchant choices by excluding one or more merchants with which the second user conducted a transaction using the second account within a predetermined time period;
generate an authentication question comprising at least one false merchant choice from the modified set of false merchant choices;
generate, based on the first account data and the modified set of false merchant choices, a correct answer to the authentication question;
provide the authentication question to the user device;
receive, from the user device, a response to the authentication question;
compare the response to the authentication question to the correct answer; and
grant the user device access to the first account based on the response to the authentication question matching the correct answer.

17. The computer-readable media of claim 16, wherein the instructions, when executed by the one or more processors, cause the computing device to:
receive data indicating that the first user and the second user are associated with a same account.

18. The computer-readable media of claim 16, wherein the instructions, when executed by the one or more processors, cause the computing device to:
after determining that the first user is related to the second user, determine, from the one or more databases, one or more accounts associated with the second user; and
exclude, from the set of modified false merchant choices, the one or more merchants with which the second user conducted one or more transactions using the one or more accounts within the predetermined time period.

19. The computer-readable media of claim 16, wherein:
the one or more transactions conducted by the first user correspond to a first set of merchants,
the one or more transactions conducted by the second user correspond to a second set of merchants, and
the set of modified false merchant choices do not include one or more merchants from the first set of merchants.

20. The computer-readable media of claim 19, wherein the set of modified false merchant choices do not include one or more merchants in the second set of merchants with which the second user conducted the transaction within the predetermined time period.
